(19) United States
(12) Patent Application Publication
(10) Pub. No.: US 2015/0288092 A1
(43) Pub. Date: Oct. 8, 2015

(54) Consolidated Universal Low Profile Marine Power Outlet

(71) Applicant: EATON CORPORATION, CLEVELAND, OH (US)

(72) Inventors: Paul David Seff, Williamsburg, VA (US); Christopher Emmons Drueke, Williamsburg, VA (US)

(73) Assignee: EATON CORPORATION, CLEVELAND, OH (US)

(21) Appl. No.: 14/246,011

(22) Filed: Apr. 4, 2014

(51) Int. Cl. H01R 13/52; B63J 99/00

(52) U.S. Cl. CPC H01R 13/5213; B63J 99/00

(57) ABSTRACT

A marine power outlet assembly is described herein. The assembly comprising: a plurality of electrical power outlets with a plurality of wiring; a front cover providing protection and rain resistance to a plurality of wiring of the plurality of electrical power outlets; a plurality of fasteners securing the front cover to the assembly and positioning the front cover for providing access to the plurality of the wiring of the plurality of electrical power outlets.

### BRIEF DESCRIPTION OF THE DRAWINGS

For a more complete understanding of the present invention, including its features and advantages, reference is now made to the detailed description of the invention taken in conjunction with the accompanying drawing in which:

FIG. 1 illustrates a front view of an embodiment of a marine power outlet 100 according to the current invention;

FIG. 2 illustrates a back view of the marine power outlet 100 of the embodiment of FIG. 1;

FIG. 3 illustrates a side view of the marine power outlet 100 of the embodiment of FIG. 1;

FIG. 4 illustrates a bottom view of the marine power outlet 100 of the embodiment of FIG. 1;

FIG. 5 illustrates a front view of a design of a marine power outlet 100; and

FIG. 6 illustrates the front view of the design of the marine power outlet 100 while the front cover is open.

### DETAILED DESCRIPTION OF THE INVENTION

While the making and using of various embodiments of the present invention are discussed in detail below, it should be appreciated that the present invention provides many applicable inventive concepts that may be embodied in a wide variety of specific contexts. The specific embodiments discussed herein are merely illustrative of specific ways to make and use the invention and do not delimit the scope of the invention.

The placement of low profile marine power outlets can cause many different types of issues. For example, the low profile marine power may susceptible to dock walkway hazards. Thus, one resolution to this type of issue is reducing difficult removal of receptacle plates and associated fasteners to service and operate the marine power.

In one embodiment of the present invention, a marine power outlet that provides a low profile pop with angled outlets for attachment of electrical cords to the outlet prevent dock walkway trip hazards.

In this embodiment, receptacle plates are angled to provide cord connection strain relief and rain resistance. This marine power outlet also includes a top plate attached with one or two fasteners to secure the top plate to the power outlet assembly while providing ease for removal. The top receptacle also protects tension from connection of electrical cords to the power outlet. In this embodiment, receptacle plates have a universal design to fit 20 A GFCI, 30 A or 50 A marine receptacles. In addition, this design also allows the top (front) covers to be rotated up in case of one fastener or flipped up in case of two fasteners, to provide mounting access and ease of wiring. The design also provides removal of the top cover via the attachment fastener(s).

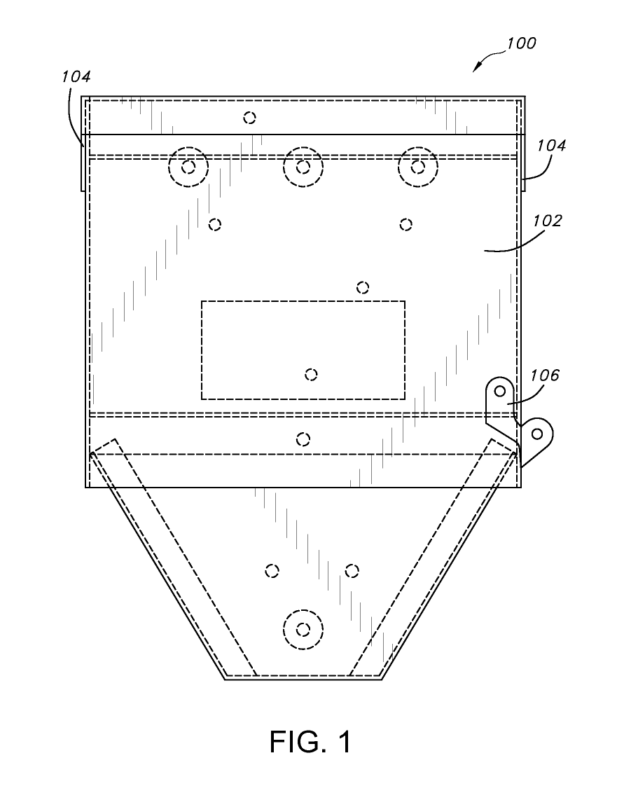

FIG. 1 illustrates a front view of an embodiment of a marine power outlet 100 with a front cover 102. The front cover 102 is attached to the marine power outlet 100 by fasteners 104. An attachment 106 is also shown attached to the front cover 102. The lip 106 assists opening the front cover 102 for mounting access and ease of wiring.

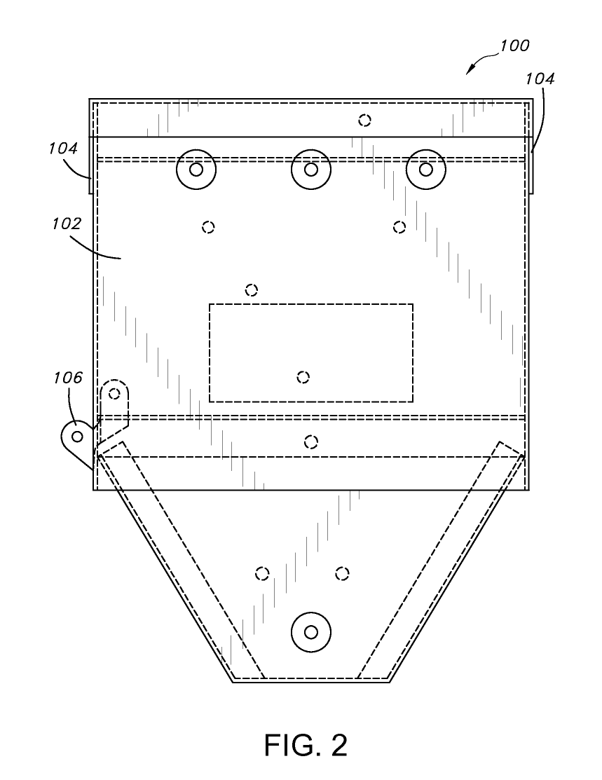

FIG. 2 illustrates a back view of the marine power outlet 100, the front cover 102, the fasteners 104 and the attachment 106.

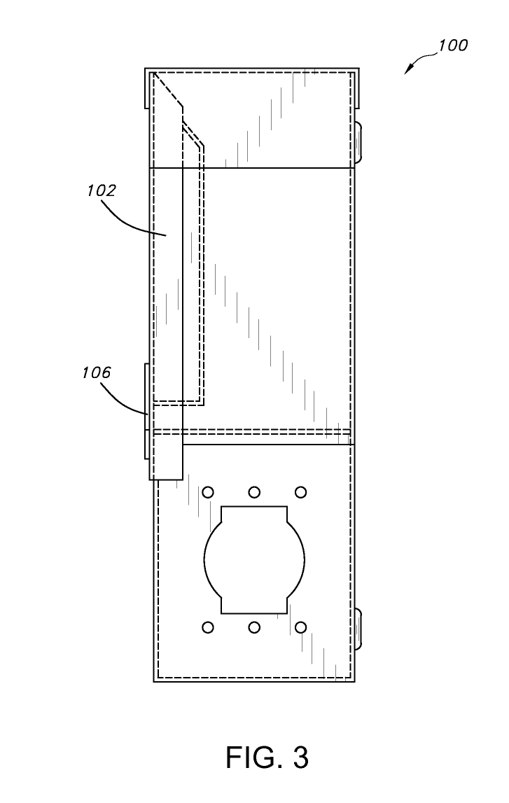

FIG. 3 illustrates a side view of the marine power outlet 100, the front cover 102, the fasteners 104 and the attachment 106. The fasteners are not shown in this figure.

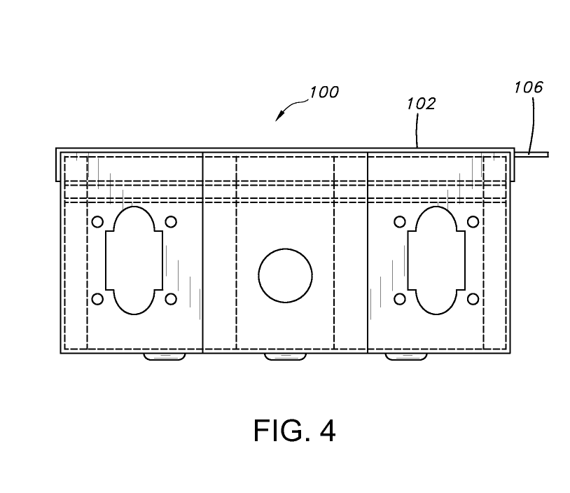

FIG. 4 illustrates a bottom view of the marine power outlet 100, the front cover 102, the fasteners 104 and the attachment 106. The fasteners are not shown in this figure either.

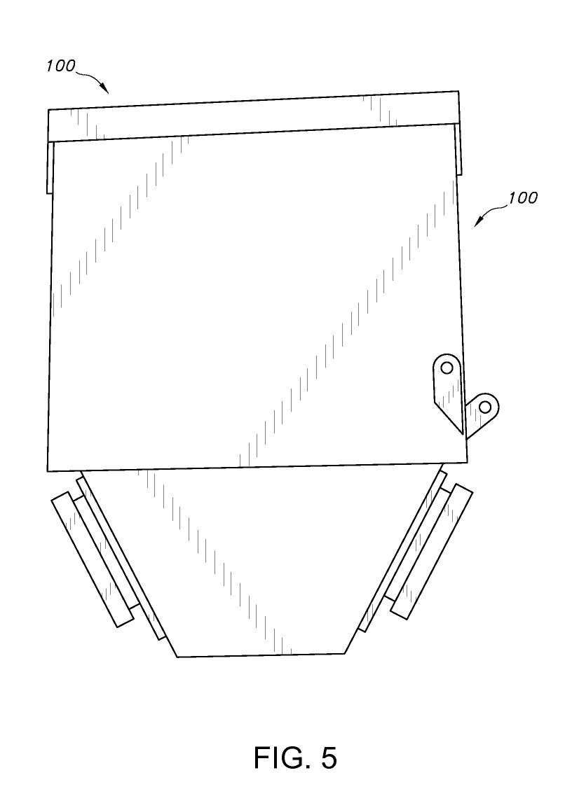

In addition, FIG. 5 illustrates a front view of a design of a marine power outlet 100.

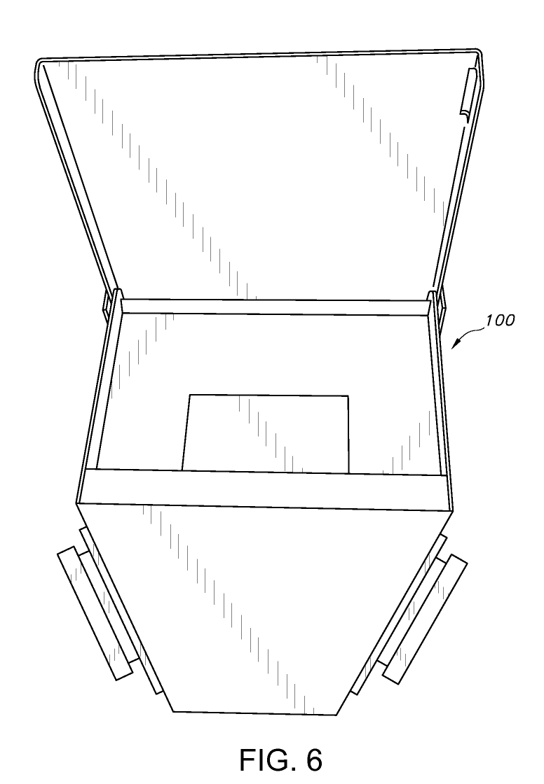

Further, FIG. 6 illustrates the front view of the design of the marine power outlet 100 while the front cover is open.

Although this invention has been described with reference to an illustrative embodiment, this description is not intended to limit the scope of the invention. Various modifications and combinations of the illustrative embodiments as well as other embodiments of the invention will be apparent to persons skilled in the art upon reference to the description. It is therefore intended that the appended claims accomplish any such modifications or embodiments.

1. A marine power outlet assembly comprising:
a first electrical power outlet with a first number of wires and a first receptacle plate;
a second electrical power outlet with a second number of wires and a second receptacle plate;
a front cover providing protection and rain resistance to the first number of wires and the second number of wires, the front cover having a plane extending between the first receptacle plate and the second receptacle plate;
a plurality of fasteners securing the front cover to the assembly and positioning the front cover for providing access to the first number of wires and the second number of wires;
wherein when viewed from a top plan perspective the first receptacle plate is disposed at a first angle with respect to the plane; and
wherein, when viewed from a top plan perspective, the second receptacle plate is disposed at a second angle with respect to the plane, the first angle and the second angle being between 30 degrees and 90 degrees.

2. (canceled)

3. (canceled)

4. The assembly of claim 1 wherein the plurality of fasteners includes only two fasteners attaching the front cover to a front corner of the assembly.

5. The assembly of claim 4 wherein the two fasteners provide the front cover to be flipped up for accessing the first number of wires and the second number of wires.

6. The assembly of claim 1 wherein the assembly further comprises an attachment to the front cover that assists opening of the front cover.

7. The assembly of claim 1 wherein the assembly further comprises a third electrical power outlet with a third number of wires and a third receptacle plate; wherein the third receptacle plate is spaced from the front cover; and wherein each of the first receptacle plate and the second receptacle plate extends from the third receptacle plate to the front cover.

8. The assembly of claim 7 wherein the third receptacle plate is disposed generally parallel to the plane.

9. The assembly of claim 1 wherein each of the first angle and the second angle is between 45 degrees and 75 degrees.

10. The assembly of claim 9 wherein each of the first angle and the second angle is about 60 degrees.
